(19) United States
(12) Patent Application Publication
(10) Pub. No.: US 2006/0285274 A1
(43) Pub. Date: Dec. 21, 2006

(54) Multilayer electronic component and multilayer ceramic capacitor

(75) Inventors: Akinori Iwasaki, Minamiashigara-city (JP); Tatsuya Kojima, Tokyo (JP); Toru Tonogai, Tokyo (JP); Shogo Murosawa, Tokyo (JP); Raitaro Masaoka, Tokyo (JP); Kyotaro Abe, Tokyo (JP); Akira Yamaguchi, Fukui-city (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/443,006

(22) Filed: May 31, 2006

(30) Foreign Application Priority Data
May 31, 2005 (JP) P2005-160136

(51) Int. Cl. H01G 4/20; H01G 4/06

(52) U.S. Cl. 361/313

(57) ABSTRACT

A multilayer electronic component comprises an inner multilayer portion and a pair of outer multilayer portions. The inner multilayer portion includes a plurality of first ceramic layers and a plurality of internal circuit element conductors which are alternately laminated and contain a glass component. A component amount ratio of an amount of the glass component in the second ceramic layers to an amount of a principal component of the second ceramic layers is larger than a component amount ratio of an amount of the glass component in the first ceramic layers to an amount of a principal component of the first ceramic layers.

### BACKGROUND OF THE INVENTION

1. Field of the Invention

The present invention relates to a multilayer electronic component and a multilayer ceramic capacitor.

2. Related Background Art

An example of the known multilayer electronic components of this type is one comprising a multilayer body in which a plurality of internal circuit element conductors and ceramic layers are laminated (e.g., reference is made to Patent Document 1 and Patent Document 2). The multilayer electronic component (multilayer ceramic capacitor) described in Patent Document 1 consists of an inner multilayer portion in which the internal circuit element conductors (internal electrodes) and ceramic layers are alternately laminated, and outer multilayer portions in which ceramic layers are laminated. In the multilayer electronic component (multilayer ceramic electronic component) described in Patent Document 2, the ceramic layers contain an oxide glass.

[Patent Document 1] Japanese Patent Application Laid-Open No. 9-129486

[Patent Document 2] Japanese Patent Application Laid-Open No. 8-191031

### SUMMARY OF THE INVENTION

An object of the present invention is to provide a multilayer electronic component and a multilayer ceramic capacitor with baking unevenness well inhibited.

The Inventors conducted elaborate research on the multilayer electronic components to enable inhibition of baking unevenness and found the following new fact.

Patent Document 1 describes the multilayer electronic component consisting of the inner multilayer portion and the outer multilayer portions. The Inventors found that baking of this multilayer electronic component resulted in sintering the inner multilayer portion at lower temperatures than those for the outer multilayer portions and, in turn, causing the baking unevenness in the multilayer electronic component.

The aforementioned baking unevenness occurs not only with baking at a temperature suitable for the inner multilayer portion, but also with baking at a temperature suitable for the outer multilayer portions. Namely, the baking at the temperature suitable for the inner multilayer portion leads to failure in sufficient sintering of the outer multilayer portions. On the other hand, the baking at the temperature suitable for the outer multilayer portions leads to excessive baking of the inner multilayer portion. If the inner multilayer portion is excessively baked, there will arise a problem that the ceramic layers of the inner multilayer portion turn into a semiconductor and a problem that the internal circuit element conductors turn into spheroidized to lower the coverage.

The Inventors examined the reason why the inner multilayer portion was sintered at lower temperatures than the outer multilayer portions, and speculated that the internal circuit element conductors alternately laminated with the ceramic layers in the inner multilayer portion must function as a sintering aid for the ceramic layers in the inner multilayer portion during the baking. In recent years, with downsizing of electronic equipment, there are demands for reduction in thickness of layers in the multilayer electronic component mounted in the electronic equipment. According to the foregoing speculation, therefore, the reduction in thickness of layers will exert a significant effect of the internal circuit element conductors on each ceramic layer in the inner multilayer portion and the problem of baking unevenness will be considered to become more pronounced.

Patent Document 2 describes the multilayer electronic component with the ceramic layers containing the oxide glass, but fails to deliberate the sintering temperatures of the inner multilayer portion and the outer multilayer portions.

In light of the above-described investigation result, a multilayer electronic component according to the present invention is a multilayer electronic component comprising: an inner multilayer portion in which a plurality of first ceramic layers and a plurality of internal circuit element conductors are alternately laminated; and a pair of outer multilayer portions in which a plurality of second ceramic layers are laminated so as to interpose the inner multilayer portion between the outer multilayer portions, wherein the first and second ceramic layers contain a glass component, and wherein a component amount ratio of an amount of the glass component in the second ceramic layers to an amount of a principal component of the second ceramic layers is larger than a component amount ratio of an amount of the glass component in the first ceramic layers to an amount of a principal component of the first ceramic layers.

When a ceramic layer is made to contain a glass component, it becomes feasible to lower the sintering temperature in the ceramic layer. In the ceramic layer, the sintering temperature decreases with increase in the component amount ratio of the amount of the glass component in the ceramic layer to the amount of the principal component of the ceramic layer. In this multilayer electronic component, the component amount ratio of the second ceramic layers is larger than the component amount ratio of the first ceramic layers, so that the sintering temperature of the second ceramic layers is lower than the sintering temperature of the first ceramic layers. It is considered on the other hand that the first ceramic layers alternately laminated with the internal circuit element conductors are affected by the internal circuit element conductors to substantially lower the sintering temperature. It results in decreasing the sintering temperature both in the inner multilayer portion and in the outer multilayer portions and thus decreasing the difference of sintering temperatures between the inner multilayer portion and the outer multilayer portions. For this reason, it becomes feasible to inhibit the baking unevenness in this multilayer electronic component. The decrease in the difference of sintering temperatures between the inner multilayer portion and the outer multilayer portions decreases a shrinkage ratio difference between the inner multilayer portion and the outer multilayer portions and also suppresses occurrence of cracks. In this multilayer electronic component, the outer multilayer portions can be sufficiently sintered even if the baking is carried out in accordance with the sintering temperature of the inner multilayer portion. This enables improvement in reliability of the multilayer electronic component.

Preferably, the inner multilayer portion has a third ceramic layer located in the same layer as each internal circuit element conductor and formed so as to absorb a level difference due to a thickness of the internal circuit element conductor in a region where the internal circuit element conductor is not formed, wherein the third ceramic layer contains a glass component, and wherein a component amount ratio of an amount of the glass component in the third ceramic layer to an amount of a principal component of the third ceramic layer is larger than the component amount ratio of the first ceramic layers.

When the inner multilayer portion has the third ceramic layer formed so as to absorb the level difference due to the thickness of the internal circuit element conductor, occurrence of delamination is inhibited in this multilayer electronic component. Since the component amount ratio of the third ceramic layer is larger than the component amount ratio of the first ceramic layers, it becomes feasible to inhibit the baking unevenness in the inner multilayer portion.

Preferably, a rate of the component amount ratio of the first ceramic layers to the component amount ratio of the second ceramic layers is not less than 0.5, and less than 1.0. When the rate of the component amount ratio of the first ceramic layers to the component amount ratio of the second ceramic layers is within this range, the difference of shrinkage ratios between the inner multilayer portion and the outer multilayer portions can be reduced, so as to inhibit occurrence of cracks.

Preferably, a thickness of each internal circuit element conductor is not more than 1.5 μm, and wherein a thickness of each first ceramic layer is not more than 1.5 times the thickness of any of the internal circuit element conductors. In this case, it becomes feasible to satisfy the demands for downsizing and reduction in thickness of layers and to substantialize the multilayer electronic component with excessive baking of the outer multilayer portions well inhibited.

A multilayer ceramic capacitor according to the present invention is a multilayer ceramic capacitor comprising: an inner multilayer portion in which a plurality of first ceramic layers and a plurality of internal electrodes are alternately laminated; and a pair of outer multilayer portions in which a plurality of second ceramic layers are laminated so as to interpose the inner multilayer portion between the outer multilayer portions, wherein the first and second ceramic layers contain a glass component, and wherein a component amount ratio of an amount of the glass component in the second ceramic layers to an amount of a principal component of the second ceramic layers is larger than a component amount ratio of an amount of the glass component in the first ceramic layers to an amount of a principal component of the first ceramic layers.

In this multilayer ceramic capacitor, the difference of sintering temperatures between the outer multilayer portions and the inner multilayer portion can be decreased and the baking unevenness can be inhibited.

The present invention successfully provides the multilayer electronic component and multilayer ceramic capacitor with baking unevenness well inhibited.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a sectional view of a multilayer ceramic capacitor according to an embodiment.

FIG. 2 is an exploded perspective view of an inner multilayer portion and outer multilayer portions included in the multilayer ceramic capacitor according to the embodiment.

FIG. 3 is a table to indicate crack occurrence rates and reliability with varying rates of component amount ratios of first and second ceramic layers.

### DESCRIPTION OF THE PREFERRED EMBODIMENTS

Preferred embodiments of the present invention will be described below in detail with reference to the accompanying drawings. In the description, identical elements or elements with identical functionality will be denoted by the same reference symbols, without redundant description.

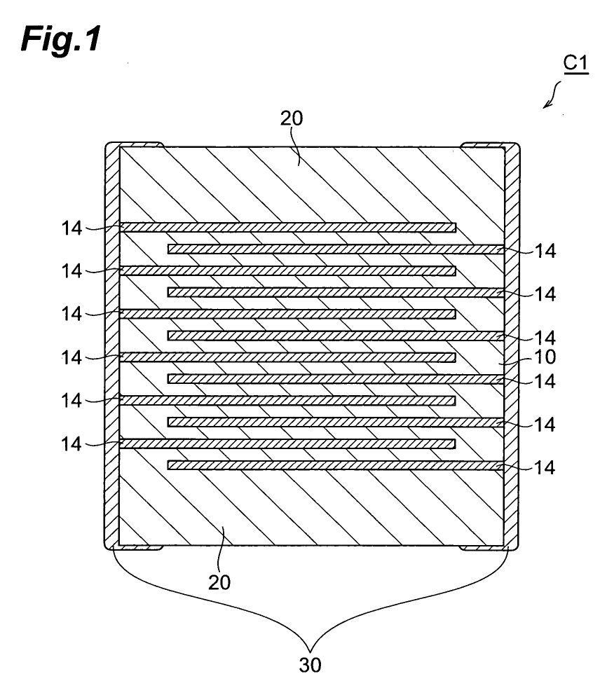

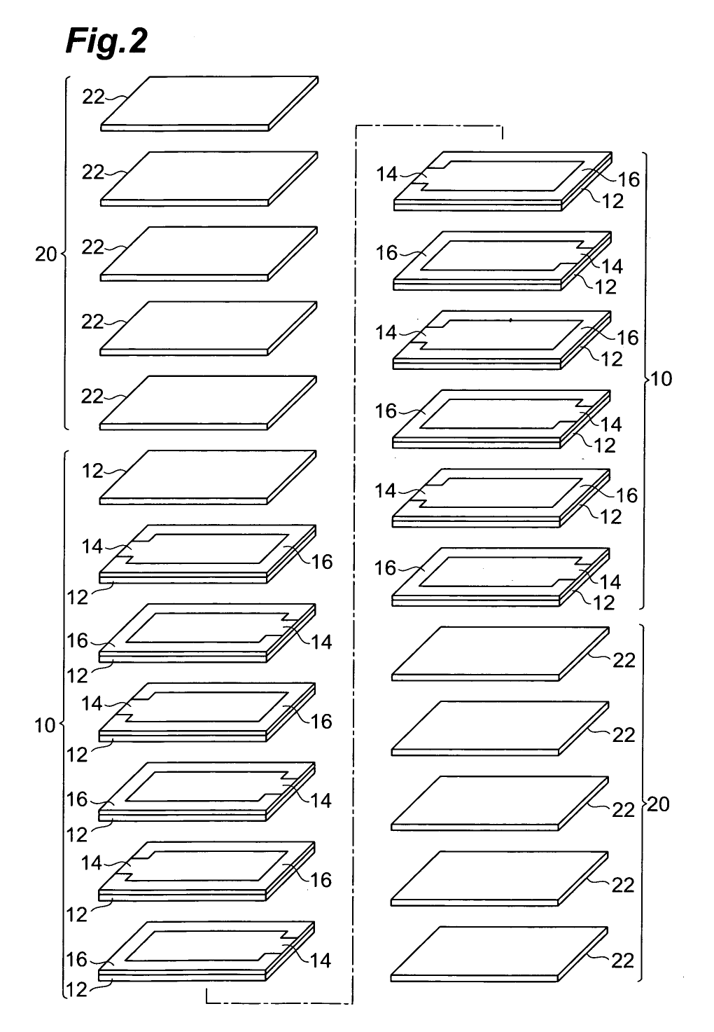

A configuration of multilayer ceramic capacitor C1 according to an embodiment will be described on the basis of FIGS. 1 and 2. FIG. 1 is a sectional view of multilayer ceramic capacitor C1 according to the embodiment. The multilayer ceramic capacitor C1, as shown in FIG. 1, comprises an inner multilayer portion 10, and a pair of outer multilayer portions 20 located so as to interpose the inner multilayer portion 10 between them. Preferably, terminal electrodes 30 are formed on outer surfaces of the multilayer ceramic capacitor C1. When the multilayer ceramic capacitor C1 is, for example, of the “1005” type, the longitudinal length is 1.0 mm, the width 0.5 mm, and the height 0.5 mm.

FIG. 2 is an exploded perspective view of the inner multilayer portion 10 and outer multilayer portions 20 in the multilayer ceramic capacitor C1 of the embodiment. The inner multilayer portion 10 includes a plurality of (thirteen in the present embodiment) first ceramic layers 12, a plurality of (twelve in the present embodiment) internal circuit element conductors 14, and a plurality of (twelve in the present embodiment) third ceramic layers 16. The plurality of first ceramic layers 12 and the plurality of internal circuit element conductors 14 are alternately laminated. The internal circuit element conductors 14 function as internal electrodes. The internal circuit element conductors 14 contain Ni as a principal component.

Each third ceramic layer 16 is located in the same layer as the corresponding internal circuit element conductor 14. Each third ceramic layer 16 is formed in a region where the corresponding internal circuit element conductor 14 is not formed, and is formed so as to absorb a level difference due to the internal circuit element conductor 14, i.e., so as to have a thickness approximately equal to a thickness of the internal circuit element conductor 14. The first and third ceramic layers 12, 16 each contain a glass component.

Each outer multilayer portion 20 is formed so that a plurality of (five in the present embodiment) second ceramic layers 22 are laminated on either side of the inner multilayer portion 10 so as to interpose the inner multilayer portion 10 between the outer multilayer portions 20. The second ceramic layers 22 contain a glass component.

A component amount ratio R1 of an amount of the glass component in the first ceramic layers 12 to an amount of the principal component (e.g., BaTiO₃) of the first ceramic layers 12 is represented by Eq (1) below.
R1=G1/M1 (1)

G1: amount of the glass component in the first ceramic layers 12

M1: amount of the principal component of the first ceramic layers 12

A component amount ratio R2 of an amount of the glass component in the second ceramic layers 22 to an amount of the principal component (e.g., BaTiO₃) of the second ceramic layers 22 is represented by Eq (2) below.
R2=G2/M2 (2)

G2: amount of the glass component in the second ceramic layers 22

M2: amount of the principal component of the second ceramic layers 22

A component amount ratio R3 of an amount of the glass component in the third ceramic layers 16 to an amount of the principal component (e.g., BaTiO₃) of the third ceramic layers 16 is represented by Eq (3) below.
R3=G3/M3 (3)

G3: amount of the glass component in the third ceramic layers 16

M3: amount of the principal component of the third ceramic layers 16

It is noted that the amounts of the principal components of the respective ceramic layers 12, 22, 16 and the amounts of the glass components in the ceramic layers 12, 22, 16 are, for example, their weights.

The component amount ratio R2 of the second ceramic layers 22 is larger than the component amount ratio R1 of the first ceramic layers 12, R1<R2. The component amount ratio R3 of the third ceramic layers 16 is larger than the component amount ratio R1 of the first ceramic layers 12, R1<R3.

A rate R1/R2 of the component amount ratio R1 of the first ceramic layers 12 to the component amount ratio R2 of the second ceramic layers 22 is not less than 0.5, and less than 1.0 and, more preferably, not less than 0.7, and less than 1.0.

The thickness of each internal circuit element conductor 14 is not more than 1.5 μm. In this case, the thickness of each first ceramic layer 12 is not more than 1.5 times the thickness of any of the internal circuit element conductors 14.

When a ceramic layer contains a glass component, sinterability of ceramic particles is improved to lower the sintering temperature. In the ceramic layer, the sintering temperature decreases with increase in the component amount ratio of the amount of the glass component in this ceramic layer to the amount of the principal component of the ceramic layer. Each of the first and second ceramic layers 12, 22 in the multilayer ceramic capacitor C1 contains the glass component. In addition, the component amount ratio R2 of the second ceramic layers 22 is larger than the component amount ratio R1 of the first ceramic layers 12. In the multilayer ceramic capacitor C1, therefore, it becomes feasible to make the sintering temperature of the second ceramic layers 22 in the outer multilayer portions 20 lower than the sintering temperature of the first ceramic layers 12 in the inner multilayer portion 10.

On the other hand, since the first ceramic layers 12 are alternately laminated with the internal circuit element conductors 14, they are affected by the internal circuit element conductors 14. The effect of the internal circuit element conductors 14 results in substantially lowering the sintering temperature of the first ceramic layers 12.

It results in decreasing the both sintering temperatures of the first and second ceramic layers 12, 22 and enables reduction in the difference of sintering temperatures between the inner multilayer portion 10 and the outer multilayer portions 20. The reduction in the difference of sintering temperatures between the inner multilayer portion 10 and the outer multilayer portions 20 enables inhibition of baking unevenness in the multilayer ceramic capacitor C1.

This inhibition of baking unevenness prevents the inner multilayer portion 10 from being excessively baked. This also prevents the conversion of the first ceramic layers 12 into a semiconductor due to abnormal grain growth and also prevents the reduction of coverage caused by increase in thickness due to the spheroidization of the internal circuit element conductors 14.

This decrease in the difference of sintering temperatures between the inner multilayer portion 10 and the outer multilayer portions 20 leads to reduction in the shrinkage ratio difference between the inner multilayer portion 10 and the outer multilayer portions 20. This inhibits occurrence of cracks in the multilayer ceramic capacitor C1.

Since the sintering temperature of the second ceramic layers 22 constituting the outer multilayer portions 20 is decreased, the outer multilayer portions 20 can be sintered well even if the multilayer ceramic capacitor C1 is baked at a temperature according to the sintering temperature of the inner multilayer portion 10. As a result, it becomes feasible to improve the reliability of this multilayer ceramic capacitor C1.

Each of the first to third ceramic layers 12, 22, 16 contains the glass component. For this reason, the sintering temperature of each ceramic layer is lowered, and it becomes feasible to decrease the temperature for baking the multilayer ceramic capacitor C1.

In the inner multilayer portion 10 of the multilayer ceramic capacitor C1, each third ceramic layer 16 is formed in the region where the corresponding internal circuit element conductor 14 is not formed. This third ceramic layer 16 is formed so as to absorb the level difference due to the thickness of the internal circuit element conductor 14. For this reason, the internal circuit element conductor 14 and third ceramic layer 16 constitute a flat plane, and it becomes feasible to suppress occurrence of delamination between the inner multilayer portion 10 and the outer multilayer portions 20 and in the inner multilayer portion 10.

The component amount ratio R3 of the third ceramic layers 16 is larger than the component amount ratio R1 of the first ceramic layers 12. For this reason, the third ceramic layers 16, each of which is formed in the region where the corresponding internal circuit element conductor 14 is not formed, and which are rarely affected by the internal circuit element conductors 14, can also be sintered at a low temperature. This enables inhibition of baking unevenness in the inner multilayer portion 10 in the multilayer ceramic capacitor C1. As a result, it becomes feasible to further improve the reliability of the multilayer ceramic capacitor C1.

In the multilayer ceramic capacitor C1, the rate of the component amount ratio R1 of the first ceramic layers 12 to the component amount ratio R2 of the second ceramic layers 22 is not less than 0.5, and less than 1.0. As far as the rate of the component amount ratios is within this range, the difference of shrinkage ratios can be kept small between the inner multilayer portion 10 and the outer multilayer portions 20. This results in further inhibiting occurrence of cracks in the multilayer ceramic capacitor C1. When the rate of the component amount ratio R1 of the first ceramic layers 12 to the component amount ratio R2 of the second ceramic layers 22 is not less than 0.7, and less than 1.0, occurrence of cracks is much more inhibited in the multilayer ceramic capacitor.

There are strong demands for downsizing and for reduction in thickness of layers in the multilayer ceramic capacitor. In the multilayer ceramic capacitor C1, the thickness of each internal circuit element conductor 14 is not more than 1.5 μm, and it is thus feasible to achieve reduction in thickness of layers. This enables downsizing of the multilayer ceramic capacitor C1 and also enables achievement of further multilayered structure.

Furthermore, in the multilayer ceramic capacitor C1, the thickness of each first ceramic layer 12 is not more than 1.5 times the thickness of any of the internal circuit element conductors 14. In the multilayer ceramic capacitor C1, therefore, it becomes feasible to suppress excessive baking of the outer multilayer portions 20. Namely, if the thickness of each internal circuit element conductor 14 is not more than 1.5 μm and if the thickness of each first ceramic layer 12 is more than 1.5 times the thickness of the internal circuit element conductors 14, the distance will be large between the first ceramic layers 12 and the internal circuit element conductors 14, so as to reduce the effect of the internal circuit element conductors 14 on the first ceramic layers 12. For this reason, substantial reduction will not occur in the sintering temperature of the first ceramic layers 12, and reduction will be achieved only in the sintering temperature of the second ceramic layers 22. This can result in excessive baking of only the outer multilayer portions 20 during the baking of the multilayer ceramic capacitor C1.

Next described is the result of investigation on a crack occurrence rate and reliability for the multilayer ceramic capacitor of the embodiment, in order to verify the inhibition of baking unevenness. The crack occurrence rate is expressed as the following:
crack occurrence rate (%)=(number of samples with crack)/(total number of samples)×100

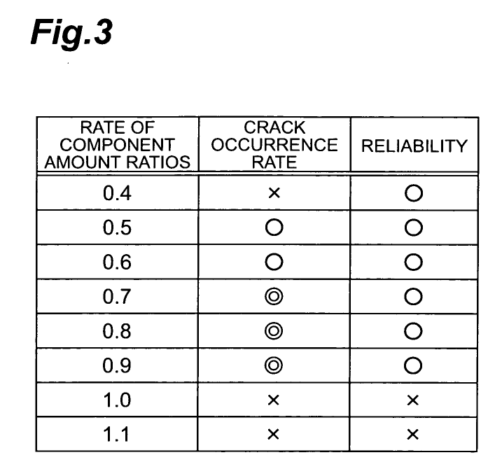

FIG. 3 shows the crack occurrence rates and reliability of multilayer ceramic capacitors where the rate of the component amount ratio of the first ceramic layers to the component amount ratio of the second ceramic layers was varied in the range of 0.4 to 1.1.

In FIG. 3, a double circle represents a case where the crack occurrence rate is less than 1%, a circle a case where the crack occurrence rate is not less than 1%, and less than 5%, and a cross a case where the crack occurrence rate is not less than 5%. Furthermore, high reliability is represented by a circle, and low reliability by a cross in FIG. 3. The results of reliability in FIG. 3 were obtained by applying a voltage of 1.5 times the rated voltage at the temperature of 85° C. to eighty multilayer ceramic capacitors for over 1000 hours.

It is apparent from FIG. 3 that in the multilayer ceramic capacitors the crack occurrence rate is low, less than 5%, when the rate of the component amount ratio R1 of the first ceramic layers 12 to the component amount ratio R2 of the second ceramic layers 22 is not less than 0.5, and less than 1.0. Furthermore, it is also apparent that the crack occurrence rate is lower, less than 1%, when the rate of the component amount ratio R1 of the first ceramic layers 12 to the component amount ratio R2 of the second ceramic layers 22 is not less than 0.7, and less than 1.0. It can be contemplated that the baking unevenness is inhibited in the multilayer ceramic capacitors with the low crack occurrence rate and with high reliability.

The preferred embodiment of the present invention was described above in detail, but it is noted that the present invention is by no means limited to the above embodiment. For example, the above embodiment showed the example of application of the present invention to the multilayer ceramic capacitors, but, without having to be limited to this, the present invention is also applicable to multilayer electronic components such as inductors, varistors, and thermistors, for example.

The principal component of the internal circuit element conductors 14 is not limited to Ni, but may be Cu, for example. The third ceramic layers 16 are not essential. The rate of the component amount ratio R1 of the first ceramic layers 12 to the component amount ratio R2 of the second ceramic layers 22 does not have to be not less than 0.5, and less than 1.0.

The thickness of one or more of the internal circuit element conductor 14 may exceed 1.5 μm. In addition, the thickness of one or more of the first ceramic layers 12 may exceed 1.5 times the thickness of one or more of the internal circuit element conductors 14.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A multilayer electronic component comprising:
an inner multilayer portion in which a plurality of first ceramic layers and a plurality of internal circuit element conductors are alternately laminated; and
a pair of outer multilayer portions in which a plurality of second ceramic layers are laminated so as to interpose the inner multilayer portion between the outer multilayer portions,
wherein the first and second ceramic layers contain a glass component, and
wherein a component amount ratio of an amount of the glass component in the second ceramic layers to an amount of a principal component of the second ceramic layers is larger than a component amount ratio of an amount of the glass component in the first ceramic layers to an amount of a principal component of the first ceramic layers.

2. The multilayer electronic component according to claim 1, wherein the inner multilayer portion has a third ceramic layer located in the same layer as each internal circuit element conductor and formed so as to absorb a level difference due to a thickness of the internal circuit element conductor in a region where the internal circuit element conductor is not formed,
wherein the third ceramic layer contains a glass component, and
wherein a component amount ratio of an amount of the glass component in the third ceramic layer to an amount of a principal component of the third ceramic layer is larger than the component amount ratio of the first ceramic layers.

3. The multilayer electronic component according to claim 1, wherein a rate of the component amount ratio of the first ceramic layers to the component amount ratio of the second ceramic layers is not less than 0.5, and less than 1.0.

4. The multilayer electronic component according to claim 1, wherein a thickness of each internal circuit element conductor is not more than 1.5 μm, and
wherein a thickness of each first ceramic layer is not more than 1.5 times the thickness of any of the internal circuit element conductors.

5. A multilayer ceramic capacitor comprising:
an inner multilayer portion in which a plurality of first ceramic layers and a plurality of internal electrodes are alternately laminated; and
a pair of outer multilayer portions in which a plurality of second ceramic layers are laminated so as to interpose the inner multilayer portion between the outer multilayer portions,
wherein the first and second ceramic layers contain a glass component, and
wherein a component amount ratio of an amount of the glass component in the second ceramic layers to an amount of a principal component of the second ceramic layers is larger than a component amount ratio of an amount of the glass component in the first ceramic layers to an amount of a principal component of the first ceramic layers.
